(19) United States
(12) Patent Application Publication
(10) Pub. No.: US 2007/0082624 A1
(43) Pub. Date: Apr. 12, 2007

(54) System and method for transmitting/receiving signal in mobile communication system using multiple input multiple output scheme

(75) Inventors: Young-Ho Jung, Seoul (KR); Yung-Soo Kim, Seongnam-si (KR); Seung-Hoon Nam, Seoul (KR); Vahid Tarokh, Cambridge, MA (US)

Correspondence Address: THE FARRELL LAW FIRM, 333 EARLE OVINGTON BOULEVARD., SUITE 701, UNIONDALE, NY, 11553, US

(73) Assignee: SAMSUNG ELECTRONICS CO., LTD., Suwon-si (KR)

(21) Appl. No.: 11/527,981

(22) Filed: Sep. 27, 2006

(30) Foreign Application Priority Data
Sep. 27, 2005 (KR) 89968-2005

(51) Int. Cl. H04B 1/02; H04B 7/02

(52) U.S. Cl. 455/101

(57) ABSTRACT

Disclosed is a mobile communication system using a Multiple Input Multiple Output (MIMO) scheme. A transmitter of the mobile communication system, generates a unitary space-time matrix to correspond to a codeword if the codeword to be transmitted in a first time interval is input, multiplies the unitary space-time matrix by a first final transmission matrix denoting signals transmitted in a second time interval before the first time interval, thereby generating a second final transmission matrix denoting signals to be transmitted in the second time interval, and transmits signals corresponding to the second final transmission matrix through a plurality of transmit antennas in the second time interval.

### PRIORITY

This application claims priority under 35 U.S.C. §119 to an application filed in the Korean Intellectual Property Office on Sep. 27, 2005 and assigned Serial No. 2005-89968, the contents of which are incorporated herein by reference.

### BACKGROUND OF THE INVENTION

1. Field of the Invention

The present invention relates generally to a system and a method for transmitting/receiving signals in a mobile communication system using a Multiple Input Multiple Output (MIMO) scheme, which will be referred to as a MIMO mobile communication system, and in particular, to a system and a method for transmitting/receiving signals by using a differential Spatial Multiplexing (SM) scheme.

2. Description of the Related Art

The most fundamental issue in communication concerns how efficiently and reliably data can be transmitted through a channel. The next generation multimedia mobile communication system, which has been actively researched in recent years, requires a high-speed communication system capable of processing and transmitting various information such as image and wireless data, rather than an initial communication system providing only a voice-based service. Accordingly, it is indispensable to improve system efficiency by using a channel coding scheme appropriate for a mobile communication system.

In contrast with wired channel environments, in wireless channel environments existing in a mobile communication system, information can be lost due to an unavoidable error caused by various factors such as multipath interference, shadowing, electric wave attenuation, time-varying noise, interference and fading. The information loss can become a factor for deteriorating the entire performance of the mobile communication system because it can actually cause a significant distortion in transmitted signals. Generally, in order to reduce the information loss as described above, it is necessary to improve the reliability of a system by using various error control techniques based on characteristics of channels. From among these error control techniques, an error-correcting code is basically used.

A diversity scheme is used to remove the instability of communication due to fading. The diversity scheme can be largely classified as a time diversity scheme, a frequency diversity scheme, and an antenna diversity scheme, i.e. a space diversity scheme.

The antenna diversity scheme uses multiple antennas, which can be classified as a receive antenna diversity scheme including and applying a plurality of receive antennas, a transmit antenna diversity scheme including and applying a plurality of transmit antennas, a MIMO scheme including and applying a plurality of receive antennas and a plurality of transmit antennas, and a Multiple Input Single Output (MISO) scheme.

The MIMO scheme and MISO scheme are types of space-time block coding schemes. In a space-time block coding scheme, signals coded in a preset coding scheme are transmitted using a plurality of transmit antennas so as to expand a coding scheme in a time domain to a space domain for achieving a lower error rate.

When a MIMO mobile communication system assumes a slow fading channel environment, the space-time block coding scheme is well known as a scheme capable of providing superior performance through a relatively simple decoding process.

Generally, it is assumed that a Channel State Information (CSI) is useful in a receiver-side within the space-time block coding scheme. Actually, the CSI is estimated using a training symbol. However, a scheme not estimating the CSI in the receiver-side is preferable because of both cost reduction and reduction in the degree of complexity of a receiver. The representative example corresponds to a case where a MIMO mobile communication system assumes a fast fading channel environment.

As described above, the space-time block coding scheme is not suitable to a case where a MIMO mobile communication system assumes a fast fading channel environment because a receiver-side must inevitably estimate the CSI. As a result, a differential space-time block coding scheme has been provided in order to achieve the performance of the space-time block coding scheme in the fast fading channel environment. For example, the differential space-time block coding scheme causes performance loss of about 3 dB as compared to the space-time block coding scheme, but it is nearly similar to the space-time block coding scheme in terms of the degree of decoding complexity.

When a MIMO mobile communication system using the differential space-time block coding scheme employs a high-order modulation scheme, e.g. a 16 Quadrature Amplitude Modulation (QAM) scheme, as a modulation scheme, average transmit power of transmitted signals increases due to the characteristics of a differential modulation scheme. Accordingly, when a MIMO mobile communication system uses the differential space-time block coding scheme, the MIMO mobile communication system can only use a low-order modulation scheme, i.e. a Phase Shift Keying (PSK)-based modulation scheme including a Quadrature PSK scheme, a 8 PSK scheme, a 16 PSK scheme, etc., which results in limitation in a modulation scheme.

In the differential space-time block coding scheme, signals are transmitted using a unitary space-time matrix. In such a case, when the transmitted signals are real number signals, a symbol transmission rate is limited to a maximum rate of 1 for all transmit antennas. When the transmitted signals are complex number signals, a symbol transmission rate is limited to a maximum rate of ¾ for specific transmit antennas among multiple transmit antennas.

Accordingly, it is necessary to provide a signal transmission/reception method in a MIMO mobile communication system, in which no limitation exists in supportable symbol transmission rates, and the CSI estimation by a receiver is not necessary.

### SUMMARY OF THE INVENTION

Accordingly, the present invention has been made to solve the above-mentioned problems occurring in the conventional art, and it is an object of the present invention to provide a system and a method for transmitting/receiving signals by using a differential SM scheme in a MIMO mobile communication system.

It is another object of the present invention to provide a system and a method for transmitting/receiving signals by using a differential SM scheme in a MIMO mobile communication system, in which no limitation exists in supportable symbol transmission rates.

It is yet another object of the present invention to provide a system and a method for transmitting/receiving signals by using a differential SM scheme in a MIMO mobile communication system, in which CSI estimation is not necessary.

In accordance with an aspect of the present invention, there is provided a system for transmitting signals in a mobile communication system using a MIMO scheme, the system including a transmission matrix generator for, if a codeword to be transmitted in a first time interval is input, generating a unitary space-time matrix which corresponds to the codeword; a multiplier for multiplying the unitary space-time matrix by a first final transmission matrix denoting signals transmitted in a second time interval before the first time interval, thereby generating a second final transmission matrix denoting signals to be transmitted in the second time interval; and a Radio Frequency (RF) processor for transmitting signals corresponding to the second final transmission matrix through a plurality of transmit antennas in the second time interval.

In accordance with another aspect of the present invention, there is provided a system for receiving signals in a mobile communication system using a MIMO scheme, the system including: an equivalent channel matrix generator for, if signals are received in a first time interval through a plurality of receive antennas, generating an equivalent channel matrix by using signals received in a second time interval before the first time interval; and a MIMO detector for restoring a codeword, which has been transmitted from a transmitter corresponding to the receiver, from the received signals by using the equivalent channel matrix.

In accordance with further another aspect of the present invention, there is provided a method for transmitting signals by a transmitter in a mobile communication system using a MIMO scheme, the method including if a codeword to be transmitted in a first time interval is input, generating a unitary space-time matrix which corresponds to the codeword; multiplying the unitary space-time matrix by a first final transmission matrix denoting signals transmitted in a second time interval before the first time interval, thereby generating a second final transmission matrix denoting signals to be transmitted in the second time interval; and transmitting signals corresponding to the second final transmission matrix through a plurality of transmit antennas in the second time interval.

In accordance with yet another aspect of the present invention, there is provided a method for receiving signals by a receiver in a mobile communication system using a MIMO scheme, the method including if signals are received in a first time interval through a plurality of receive antennas, generating an equivalent channel matrix by using signals received in a second time interval before the first time interval; and restoring a codeword, which has been transmitted from a transmitter corresponding to the receiver, from the received signals by using the equivalent channel matrix.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically illustrating the structure of a Multiple Input Multiple Output (MIMO) mobile communication system according to the present invention;

FIG. 2 is a block diagram schematically illustrating the structure of the transmission matrix generator in FIG. 1;

FIG. 3 is a graph illustrating a comparison between performance achieved when a Multiple Input Multiple Output (MIMO) mobile communication system uses a general differential space-time block coding scheme and performance achieved when the MIMO mobile communication system uses a differential Spatial Multiplexing (SM) scheme according to the present invention; and

FIG. 4 is a graph illustrating a comparison between performance achieved when a Multiple Input Multiple Output MIMO) mobile communication system applies a normalization weight according to the present invention and performance achieved when the MIMO mobile communication system does not apply the normalization weight.

### DETAILED DESCRIPTION OF THE PREFERRED EMBODIMENT

A preferred embodiment of the present invention will be described in detail herein below with reference to the accompanying drawings. In the following description, a detailed description of known functions and configurations incorporated herein will be omitted when it may obscure the subject matter of the present invention.

The present invention provides a system and a method for transmitting/receiving signals in a mobile communication system using a Multiple Input Multiple Output (MIMO) scheme, which will be referred to as a MIMO mobile communication system. Specifically, the present invention provides a system and a method for transmitting/receiving signals by using a new differential Spatial Multiplexing (SM) scheme in a MIMO mobile communication system, in which no limitation exists in available modulation schemes, and supportable symbol transmission rates are also not limited.

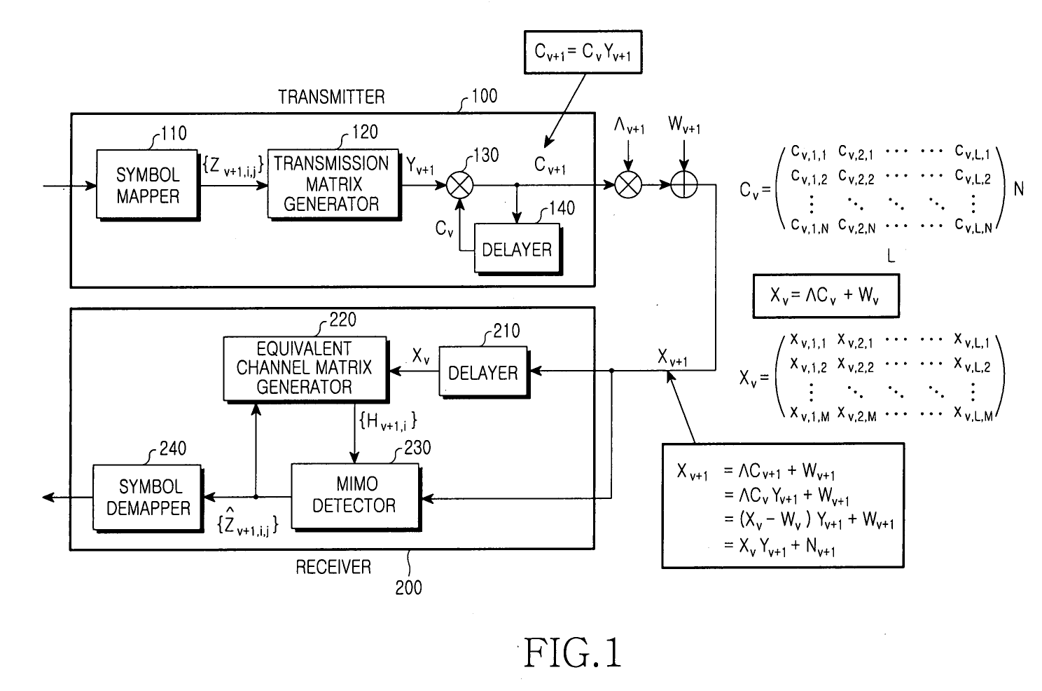

FIG. 1 is a block diagram schematically illustrating the structure of a MIMO mobile communication system according to the present invention. Referring to FIG. 1, the MIMO mobile communication system includes a transmitter 100 and a receiver 200. The transmitter 100 includes a symbol mapper 110, a transmission matrix generator 120, a multiplier 130 and a delayer 140, and the receiver 200 includes a delayer 210, an equivalent channel matrix generator 220, a MIMO detector 230 and a symbol demapper 240.

First, if binary bits are input to the symbol mapper 110, it symbol-maps the binary bits by using a preset symbol mapping scheme, and outputs the mapped binary bits to the transmission matrix generator 120. The binary bits can also be information data bits before coding, or coded bits into which the information data bits have been coded by using a preset coding scheme. However, since the binary bits have no direct connection to the present invention, details will be omitted here. Hereinafter, signals output from the symbol mapper 110 will be referred to as a modulation symbol, and a modulation symbol output from the symbol mapper 110 will be expressed by {z_{v+1,i,j})}.

In the modulation symbol {z_{v+1, i, j})}, v denotes the index of a corresponding transmission time interval, i denotes the index of blocks constituting a codeword, and j denotes a transmit antenna index. It is assumed that the codeword includes a plurality of modulation symbols, i.e. a plurality of blocks, and one codeword includes L blocks. In the present invention, it is assumed that the number of transmit antennas used by the transmitter 100 is N and the number of receive antennas used by the receiver 200 is M. Thus, the transmit antenna index j may be expressed by (1, 2, . . . , N) (j=1, 2, . . . , N), and the block index i may be expressed by (1, 2, . . . , L) (i=1, 2, . . . , L). That is, the modulation symbol {z_{v+1,i,j})} denotes an i^{th} block transmitted through a j^{th} transmit antenna in a (v+1)^{th} transmission time interval.

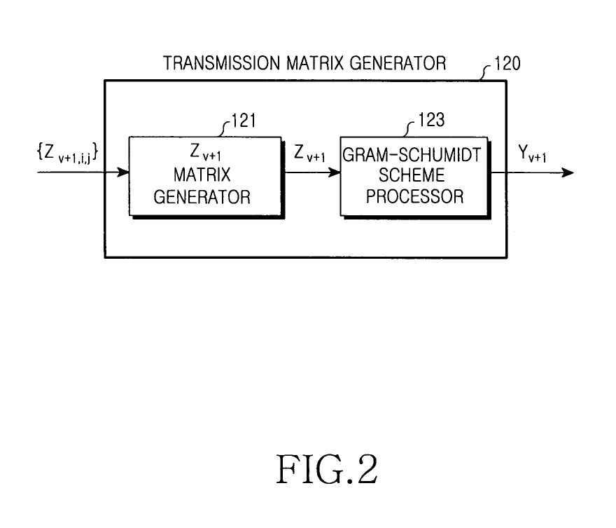

If the modulation symbol {z_{v+1,i,j})} output from the symbol mapper 110 is input, the transmission matrix generator 120 generates a matrix z₍ᵥ₊₁₎ by using a preset scheme, generates a unitary space-time matrix Y₍ᵥ₊₁₎ by applying a Gram-Schumidt scheme to the matrix z₍ᵥ₊₁₎, and outputs the unitary space-time matrix Y₍ᵥ₊₁₎ to the multiplier 130. The unitary space-time matrix Y₍ᵥ₊₁₎ is a (L X L) matrix including information about the modulation symbol {z_{v+1, i, j}}, and the transmission matrix generator 120 generates the unitary space-time matrix by the codeword. Since the internal construction and detailed operation of the transmission matrix generator 120 will be described in detail with reference to FIG. 2, details will be omitted here.

The multiplier 130 multiplies the unitary space-time matrix Y₍ᵥ₊₁₎ by final transmission signals Cᵥ in a v^{th} time interval, which are output from the delayer 140, so as to generate final transmission signals C₍ᵥ₊₁₎ in a (v+1)^{th} time interval, and outputs the final transmission signals C₍ᵥ₊₁₎. That is, the final output signals C₍ᵥ₊₁₎ transmitted from the transmitter 100 in the (v+1)^{th} time interval can be expressed by Equation (1) below.
C₍ᵥ₊₁₎=CᵥY₍ᵥ₊₁₎ (1)

As expressed by Equation (1), the final output signals C₍ᵥ₊₁₎ transmitted from the transmitter 100 in the (v+1)^{th} time interval is expressed as the product of the final transmission signals Cᵥ in the v^{th} time interval, which is a previous time interval, and the unitary space-time matrix Y₍ᵥ₊₁₎ corresponding to signals to be actually transmitted by the transmitter 100. This is because the transmitter 100 uses a differential SM scheme. Further, the final output signals C₍ᵥ₊₁₎ is a (N X L) matrix. Herein, L denotes a codeword length, rows in the (N X L) matrix of the final output signals C₍ᵥ₊₁₎ are perpendicular to one another, and columns are also perpendicular one another.

The final output signals C₍ᵥ₊₁₎ are transmitted through N transmit antennas (not shown) used by the transmitter 100, the transmitted final output signals C₍ᵥ₊₁₎ becomes signals including noise while experiencing channel conditions, and then are received through M receive antennas (not shown) of the receiver 200. That is, the signals received in the receiver 200 can be expressed by Equation (2) below.
X₍ᵥ₊₁₎=ΛC₍ᵥ₊₁₎+W₍ᵥ₊₁₎ (2)

In Equation (2), X₍ᵥ₊₁₎ denotes signals received in the receiver 200 in the (v+1)^{th} time interval, A denotes a channel response, and W₍ᵥ₊₁₎ denotes noise in the (v+1)^{th} time interval. In Equation (2), the final transmission signals Cᵥ in the v^{th} time interval can be expressed by Equation 3) below.

$${C}_{v} = ( \begin{matrix}{C}_{v , 1 , 1} & {C}_{v , 2 , 1} & … & … & {C}_{v , L , 1} \\ {C}_{v , 1 , 2} & {C}_{v , 2 , 2} & … & … & {C}_{v , L , 2} \\ ⋮ & ⋰ & ⋰ & ⋰ & ⋮ \\ {C}_{v , 1 , N} & {C}_{v , 2 , N} & … & … & {C}_{v , L , N}\end{matrix} ) \qquad ( 3 )$$

In Equation (3), each row corresponds to N transmit antennas and each column corresponds to a codeword length L. That is, the codeword includes the total L blocks from a first block to an L^{th} block. In equation 3, C_{v,L,N} denotes the L^{th} block transmitted through an N^{th} transmit antenna in the v^{th} time interval.

As described above, since the final output signals C₍ᵥ₊₁₎ in the (v+1)^{th} time interval are expressed as the product of the final transmission signals Cᵥ in the v^{th} time interval, which is a previous time interval, and the unitary space-time matrix Y₍ᵥ₊₁₎ in the (v+1)^{th} time interval, Equation (2) can be expressed by Equation (4) below.
X₍ᵥ₊₁₎=ΛCᵥY₍ᵥ₊₁₎+W₍ᵥ₊₁₎ (4)

If Equation (4) is deployed for the unitary space-time matrix Yᵥ₊₁, it can be expressed by Equation (5) below.
X₍ᵥ₊₁₎=(Xᵥ−W_{V})Y₍ᵥ₊₁₎+W₍ᵥ₊₁₎ (5)

In Equation (5), Xᵥ denotes signals received in the receiver 200 in the v^{th} time interval, which can be expressed by Equation (6) below.

$${X}_{v} = ( \begin{matrix}{x}_{v , 1 , 1} & {x}_{v , 2 , 1} & … & … & {x}_{v , L , 1} \\ {x}_{v , 1 , 2} & {x}_{v , 2 , 2} & … & … & {x}_{v , L , 2} \\ ⋮ & ⋰ & ⋰ & ⋰ & ⋮ \\ {x}_{v , 1 , M} & {x}_{v , 2 , M} & … & … & {x}_{v , L , M}\end{matrix} ) \qquad ( 6 )$$

In Equation (6), each row corresponds to M receive antennas and each column corresponds to a codeword length L. That is, in Equation (6), x_{v,i,p} denotes an i^{th} block received through a p^{th} receive antenna in the v^{th} time interval. Herein, p denotes the index of a receive antenna.

If signals except for XᵥX₍ᵥ₊₁₎ in Equation (5) are newly defined by means of noise N₍ᵥ₊₁₎, the signals may be expressed by Equation (7) below.
X₍ᵥ₊₁₎=XᵥY₍ᵥ₊₁₎+N₍ᵥ₊₁₎ (7)

As such, the reception signals X₍ᵥ₊₁₎in the (v+1)^{th} time interval, which are received through the M receive antennas, are input to the delayer 210 and the MIMO detector 230. The delayer 210 delays the reception signals X₍ᵥ₊₁₎ by a preset time period, i.e. one time interval, and outputs the delayed signals to the equivalent channel matrix generator 220. The one time interval denotes a time interval in which all the codewords are transmitted. Accordingly, when the receiver 200 receives the reception signals X₍ᵥ₊₁₎, the delayer 210 outputs the reception signals Xᵥ in the v^{th} time interval.

Then, the equivalent channel matrix generator 220 receives the reception signals Xᵥ in the v^{th} time interval, which are from the delayer 210, to generate an equivalent matrix {H_{v+1,i}}, and outputs the equivalent matrix {H_{v+1,i}}, to the MIMO detector 230. Since an operation by which the equivalent channel matrix generator 220 generates the equivalent matrix {H_{v+1,i}} will be described in detail later, details will be omitted here.

The MIMO detector 230 demodulates the reception signals X₍ᵥ₊₁₎ in the (v+1)^{th} time interval by using the equivalent matrix {H_{v+1,i}} to correspond to the scheme applied by the transmitter 100, and outputs the demodulated signals to the symbol demapper 240. Hereinafter, the signals output from the MIMO detector 230 will be referred to as a demodulation symbol, and a demodulation symbol output from the MIMO detector 230 will be expressed by {\hat{z}_{v+1,i,j}}.

The symbol demapper 240 demaps the demodulation symbol {\hat{z}_{v+1,i,j}} by using a symbol demapping scheme corresponding to the symbol mapping scheme applied by the symbol mapper 110, thereby restoring the demodulation symbol to binary bits. The binary bits may be information data bits before coding, or coded bits into which the information data bits have been coded by using a preset coding scheme. However, since the binary bits have no direct connection to the present invention, details will be omitted here.

As described in FIG. 1, when the differential space-time coding modulation scheme provided by the present invention is used, a transmitter need not limit available modulation schemes and also need not limit supportable symbol transmission rates, and a receiver can restore signals transmitted from the transmitter even without estimating separate Channel State Information.

FIG. 2 is a block diagram schematically illustrating the structure of the transmission matrix generator 120 in FIG. 1. Referring to FIG. 2, the transmission matrix generator 120 includes a Z₍ᵥ₊₁₎ matrix generator 121 and a Gram-Schumidt scheme processor 123.

As described in FIG. 1, the modulation symbol {z_{v+1,i,j}} output from the symbol mapper 110 is input to the Z₍ᵥ₊₁₎ matrix generator 121. The Z₍ᵥ₊₁₎ matrix generator 121 receives the modulation symbol {z_{v+1,i,j}} to generate a matrix Z₍ᵥ₊₁₎, and outputs the matrix Z₍ᵥ₊₁₎to the Gram-Schumidt scheme processor 123. That is, the Z₍ᵥ₊₁₎ matrix generator 121 receives the modulation symbol {z_{+1, i, j}} to generate the matrix Z₍ᵥ₊₁₎as expressed by Equation (8) below.

$${Z}_{v + 1} = ( \begin{matrix}{α}_{1 , 1} {z}_{v + 1 , 1 , 1} & 0 & … & 0 & 0 \\ {α}_{1 , 2} {z}_{v + 1 , 1 , 2} & {α}_{2 , 1} {z}_{v + 1 , 2 , 1} & … & 0 & 0 \\ 0 & {α}_{2 , 2} {z}_{v + 1 , 2 , 2} & … & 0 & 0 \\ 0 & 0 & … & 0 & 0 \\ ⋮ & ⋮ & ⋰ & ⋮ & ⋮ \\ 0 & 0 & … & {α}_{L - 1 , 1} {z}_{v + 1 , L - 1 , 1} & 0 \\ 0 & 0 & … & {α}_{L - 1 , 2} {z}_{v + 1 , L - 1 , 2} & {α}_{L , 1} {z}_{v + 1 , L , 1}\end{matrix} ) \qquad ( 8 )$$

In Equation (8), αᵢⱼ denotes a normalization weight multiplied to an iₜₕ block transmitted through an jₜₕ transmit antenna, and the matrix Z₍ᵥ₊₁₎ is a dual diagonal matrix. The matrix Z₍ᵥ₊₁₎ is a matrix when it is assumed that the transmitter 100 uses two transmit antennas, i.e. the first and second transmit antennas.

The Gram-Schumidt scheme processor 123 applies a Gram-Schumidt scheme to the matrix Z₍ᵥ₊₁₎ output from the Z₍ᵥ₊₁₎ matrix generator 121, thereby generating the unitary space-time matrix Y₍ᵥ₊₁₎ Hereinafter, an operation for generating the unitary space-time matrix Y₍ᵥ₊₁₎ by applying the Gram-Schumidt scheme to the matrix Z₍ᵥ₊₁₎ will be described in detail.

First, it is assumed that respective nonzero column vectors in the matrix Z₍ᵥ₊₁₎are (v₁, v₂, v₃, . . . , v_{L}) and respective column vectors in the unitary space-time matrix Y₍ᵥ₊₁₎ are (u₁, u₂, u₃, . . . , u_{L}). As a result of applying the Gram-Schumidt scheme, when i has a value of 1, i.e. the first column vector u₁ of the unitary space-time matrix Y₍ᵥ₊₁₎ is generated as expressed by Equation (9) below.
u₁=k₁v₁ (9)

In Equation (9), k₁ is a weight applied in order to generate the first column vector u₁ of the unitary space-time matrix Y₍ᵥ₊₁₎. Herein, k₁ exceeding zero (k₁>0) must be selected such that the first column vector u₁ becomes a unit vector (|u₁|=1). In the present invention, k₁ is set to

$$\frac{1}{\vert {v}_{1} \vert} ( {k}_{1} = \frac{1}{\vert {v}_{1} \vert} ) .$$

As a result of applying the Gram-Schumidt scheme, when i does not have a value of 1, i.e. i=2, 3, . . . , L, the second to L^{th} column vectors u₂ to u_{L} of the unitary space-time matrix Y₍ᵥ₊₁₎ are generated as expressed by Equation (10) below.
uᵢ=kᵢ(vᵢ−<v₁,u₁>u₁−vᵢ,u₂>u₂− . . . −<vᵢ,uᵢ₋₁>uᵢ₋₁) (10)

As expressed by Equation (10), kᵢ exceeding zero (kᵢ>0) must be selected so as to satisfy (|u₁|=1). Herein, kᵢ is a weight applied in order to generate an iₜₕ column vector uᵢ of the unitary space-time matrix Y₍ᵥ₊₁₎ and kᵢ exceeding zero (kᵢ>0) must be selected in such a manner that the i^{th} column vector us becomes a unit vector (|uᵢ|=1). Accordingly, the unitary space-time matrix Y₍ᵥ₊₁₎ is generated to be a matrix corresponding to the characteristics of the matrix z₍ᵥ₊₁₎ by using the Gram-Schumidt scheme. When the transmitter 100 uses two transmit antennas, column vectors of the unitary space-time matrix Y₍ᵥ₊₁₎, e.g. the first column vector u₁, the i^{th} column vector uᵢ and the L^{th} column vector u_{L} can be expressed by Equations (11) to (13) below.

$$\begin{matrix}{u}_{1} = {k}_{1} ( \begin{matrix}{α}_{11} {z}_{v + 1 , 1 , 1} \\ {α}_{12} {z}_{v + 1 , 1 , 2} \\ 0 \\ ⋮ \\ 0\end{matrix} ) & ( 11 ) \\ {u}_{i} = {k}_{i} ( \begin{matrix}{α}_{i 1} {z}_{v + 1 , i , 1} {u}_{( i - 1 ) i}^{*} {u}_{( i - 1 ) 1} \\ {a}_{i 1} {z}_{v + 1 , i , 1} {u}_{( i - 1 ) i}^{*} {u}_{( i - 1 ) 2} \\ ⋮ \\ {α}_{i 1} {z}_{v + 1 , i , 1} ( 1 - {E}_{{u}_{( i - 1 ) i}} ) \\ {α}_{i 2} {z}_{v + 1 , i , 2} \\ 0 \\ ⋮ \\ 0\end{matrix} ) & ( 12 ) \\ {u}_{L} = {k}_{L} ( \begin{matrix}{α}_{L 1} {z}_{v + 1 , L , 1} {u}_{( L - 1 ) L}^{*} {u}_{( L - 1 ) 1} \\ {α}_{L 1} {z}_{v + 1 , L , 1} {u}_{( L - 1 ) L}^{*} {u}_{( L - 1 ) 2} \\ ⋮ \\ {α}_{L 1} {z}_{v + 1 , L , 1} ( 1 - {E}_{{u}_{( L - 1 ) L}} )\end{matrix} ) & ( 13 )\end{matrix}$$

Hereinafter, an operation for determining the normalization weight α_{i,j} will be described in detail. According to the present invention, in determining the normalization weight α_{i,j}, it is necessary to consider a forcing condition in which respective signals transmitted through the first and second transmit antennas in the (v+1)^{th} time interval in the i^{th} column vector uᵢ of the unitary space-time matrix Y₍ᵥ₊₁₎ must have the same energy. That is, z_{v+1,i,1} must have the same energy as that of z_{v+1,i,2}. This is for minimizing the equal error protection and pair-wise error probability of z_{v+1,i,1} and z_{v+1,i,2}.

Under the forcing condition, the normalization weight α_{i,j} is determined corresponding to the block index i. First, when the block index i has a value of 1 (i=1), the normalization weight α_{i,j} is determined as expressed by Equation (14) below.
|α₁₁|²|z_{v+1,1,1}|=|α₁₂|²|z_{v+1,1,2}|=0.5 (14)

As expressed by Equation (14), when the block index i has a value of 1,

$${α}_{11} = {α}_{12} = \frac{1}{\sqrt{2}} .$$

Second, when the block index i has a value of (2, 3, . . . , L−1), the normalization weight α_{i,j} is determined as expressed by Equation (15) below.
|αᵢ₁|²|z_{v+1,i,1}|²{Eᵤ₍ᵢ₋₁₎ᵢΣⱼ₌₁^{i-1E}ᵤ₍ᵢ₋₁₎ᵢ+(1−Eᵤ₍₁₋₁₎ᵢ)²}=|αᵢ₂|²|z_{v+1,i,2}|²=0.5 (15)

In Equation (15), Eᵤ_{_{(i−1)i}} denotes the energy of u₍ᵢ₋₁₎ᵢ. As expressed by Equation (15), when the block index i has a value of (2, 3, . . . , L−1), then

$${α}_{i 1} = 1 , {α}_{i 2} = \frac{1}{\sqrt{2}} .$$

Third, when the block index i has a value of L (i=L), the normalization weight α_{i,j} is determined as expressed by Equation (16) below.
|α_{L1}|²|z_{v+1,L,1}|²{Eᵤ_{_{(L−1)L}}Σ^{L-1}ⱼ₌₁Eᵤ_{_{(L−1)j}}+(1−Eᵤ_{_{(L−1)L}})²}=1 (16)

As expressed by Equation (16), when the block index i has a value of L, then α_{L1}=\sqrt{2}

Hereinafter, an operation by which the receiver 200 restores the binary bits transmitted from the transmitter 100, i.e. an operation of the equivalent channel matrix generator 220, will be described in detail. First, signals received in the receiver 200 in the (v+1)^{th} time interval can be modeled by Equation (17) below.
X_{v+1,.,i}=Xᵥuᵢ+N_{v+1,.,i} (17)

Further, a linear signal model in the receiver 200 can be expressed by Equation (18) below when the block index i has a value of 1 (i=1).

$$[ \begin{matrix}{x}_{v + 1 , 1 , 1} \\ {x}_{v + 1 , 1 , 2} \\ ⋮ \\ {x}_{v + 1 , 1 , M}\end{matrix} ] = \frac{1}{\sqrt{2}} [ \begin{matrix}{x}_{v , 1 , 1} & {x}_{v , 2 , 1} \\ {x}_{v , 1 , 2} & {x}_{v , 2 , 2} \\ ⋮ & ⋮ \\ {x}_{v , 1 , M} & {x}_{v , 2 , M}\end{matrix} ] [ \begin{matrix}{z}_{v + 1 , 1 , 1} \\ {z}_{v + 1 , 1 , 2}\end{matrix} ] + [ \begin{matrix}{n}_{v + 1 , 1 , 1} \\ {n}_{v + 1 , 1 , 2} \\ ⋮ \\ {n}_{v + 1 , 1 , M}\end{matrix} ] ≡ {H}_{v + 1 , 1} \qquad ( 18 )$$

Also, the linear signal model in the receiver 200 can be expressed by Equation (19) below when the block index i has a value of (2, 3, . . . , L−1) (i=2, 3, . . . , L−1).

$$[ \begin{matrix}{x}_{v + 1 , i , 1} \\ {x}_{v + 1 , i , 2} \\ ⋮ \\ {x}_{v + 1 , i , M}\end{matrix} ] = [ \begin{matrix}- {\sum }_{j = 1}^{i - 1} {x}_{v , j , 1} {u}_{( i - 1 ) i}^{*} {u}_{( i - 1 ) j} + {x}_{v , i , 1} 1 - {E}_{{u}_{( i - 1 ) i}} \frac{1}{\sqrt{2}} {x}_{v , 2 , 1} \\ - {\sum }_{j = 1}^{i - 1} {x}_{v , j , 2} {u}_{( i - 1 ) i}^{*} {u}_{( i - 1 ) j} + {x}_{v , i , 2} 1 - {E}_{{u}_{( i - 1 ) i}} \frac{1}{\sqrt{2}} {x}_{v , 2 , 2} \\ ⋮ \\ - {\sum }_{j = 1}^{i - 1} {x}_{v , j , M} {u}_{( i - 1 ) i}^{*} {u}_{( i - 1 ) j} + {x}_{v , i , M} 1 - {E}_{{u}_{( i - 1 ) i}} \frac{1}{\sqrt{2}} {x}_{v , 2 , M}\end{matrix} ] [ \begin{matrix}{z}_{v + 1 , i , 1} \\ {z}_{v + 1 , i , 2}\end{matrix} ] + [ \begin{matrix}{n}_{v + 1 , i , 1} \\ {n}_{v + 1 , i , 2} \\ ⋮ \\ {n}_{v + 1 , i , M}\end{matrix} ] ≡ {H}_{v + 1 , i} \qquad ( 19 )$$

As described above, when the differential SM scheme according to the present invention is used, the receiver 200 needs not separately estimate the CSI, and thus the degree of complexity of a receiver caused by CSI estimation is reduced.

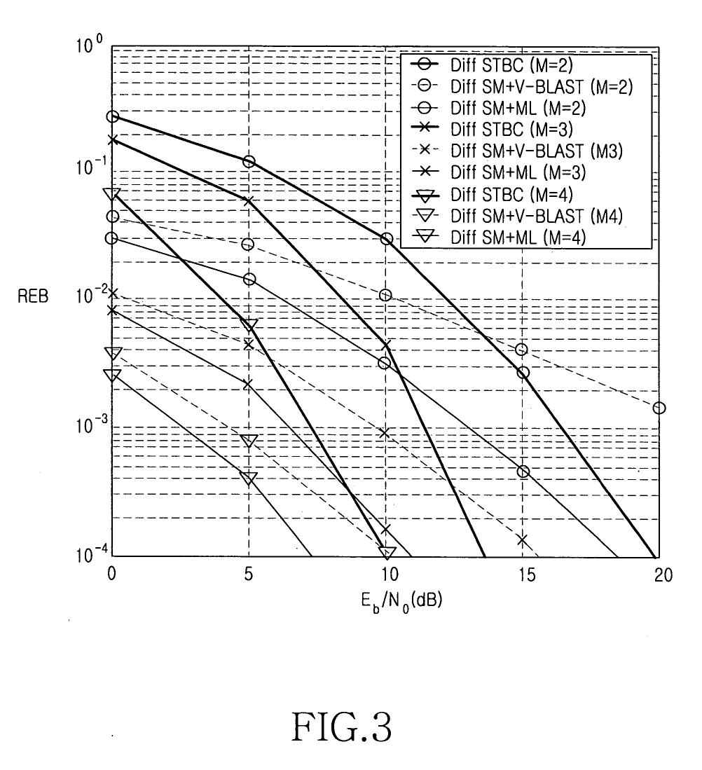

Hereinafter, a comparison between performance achieved when the MIMO mobile communication system uses a general differential space-time block coding scheme and performance achieved when the MIMO mobile communication system uses the differential SM scheme according to the present invention will be described with reference to FIG. 3.

FIG. 3 is a graph illustrating a comparison between performance achieved when the MIMO mobile communication system uses the general differential space-time block coding scheme and performance achieved when the MIMO mobile communication system uses the differential SM scheme according to the present invention.

Referring to FIG. 3, performance graphs illustrated in FIG. 3 denote performance graphs when it is assumed that the number of transmit antennas used in a transmitter is 2 (N=2), the number of receive antennas used in a receiver is two (M=2), three (M=3) or four (M=4), and a codeword has a length of 2 (L=2), i.e. a codeword includes two blocks.

Further, according to the graphs obtained when a general differential space-time block coding scheme is used, a rate of 1, i.e. a symbol transmission rate of 1 is applied because limitation exists in the symbol transmission rate, and an available modulation scheme is also limited to PSK (Phase Shift Keying) modulation schemes as described in the conventional art. In other words, the graphs correspond to performance graphs when an 8PSK scheme is applied.

However, according to the graphs obtained when the differential SM scheme according to the present invention is used, there is no limitation in transmission rates. Simply, the graphs correspond to performance graphs when a Quadrature Phase Shift Keying (QPSK) scheme is applied. Accordingly, a receiver needs not estimate the CSI, and can use predetermined schemes using the CSI, e.g. a Vertical-Bell Laboratory Layered Space-Time (V-BLAST) scheme or a Maximum Likelihood (ML) scheme.

As illustrated in FIG. 3, it can be understood that performance is improved when the differential SM scheme according to the present invention is used, as compared to a case where a general differential space-time block coding scheme is used. That is, when a transmitter uses two transmit antennas, and a receiver uses four receive antennas and employs an ML scheme, the differential SM scheme according to the embodiment of the present invention shows the best performance.

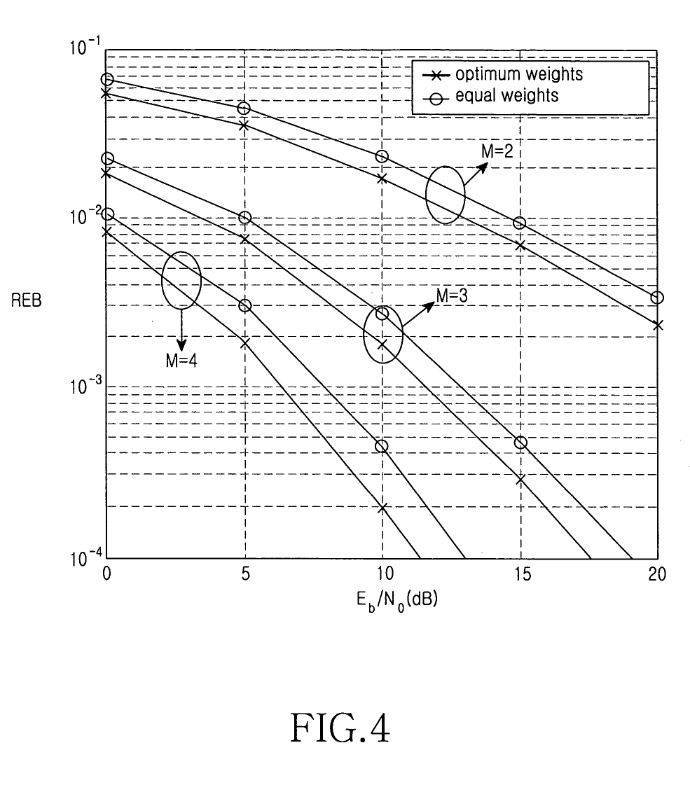

Hereinafter, a comparison between performances achieved when the MIMO mobile communication system applies a normalization weight according to the present invention and performance achieved when the MIMO mobile communication system does not apply the normalization weight will be described herein with reference to FIG. 4.

FIG. 4 is a graph illustrating a comparison between performance achieved when the MIMO mobile communication system applies the normalization weight according to the present invention and performance achieved when the MIMO mobile communication system does not apply the normalization weight. Referring to FIG. 4, performance graphs illustrated in FIG. 4 denote performance graphs when the number of transmit antennas used in a transmitter is 2 (N=2), the number of receive antennas used in a receiver is two (M=2), three (M=3) or four (M=4), a codeword has a length of 4 (L=4), i.e. a codeword includes four blocks, a QPSK scheme is used as a modulation scheme, and the receiver uses a linear Minimum Mean Squared Error (MMSE) detector.

As illustrated in FIG. 4, with the increase in the number of receive antennas, it can be understood that the performance (i.e., expressed by optimal weights) achieved when the normalization weight is applied is more improved, as compared to the performance (i.e., expressed by equal weights) achieved when the normalization weight is not applied.

As described above, the present invention provides a system and a method for transmitting/receiving signals in a MIMO mobile communication system, in which no limitation exists in available modulation schemes, supportable symbol transmission rates are also not limited, and the CSI estimation by a receiver is not necessary.

That is, it is possible to support a high symbol transmission rate which cannot be supported by a differential space-time block coding scheme generally used in a MIMO mobile communication system. Further, a receiver-side need not estimate a CSI, so that the degree of complexity of a receiver can be reduced. Furthermore, the average power problem of transmission signals is solved and thus it is not necessary to limit available modulation schemes, so that flexible signal transmission/reception is possible.

While the invention has been shown and described with reference to a certain preferred embodiment thereof, it will be understood by those skilled in the art will that various modifications, additions and substitutions in form and details are possible, without departing from the scope and spirit of the invention as defined by the appended claims, including the full scope of equivalents thereof.

What is claimed is:

1. A method for transmitting signals by a transmitter in a mobile communication system using a Multiple Input Multiple Output (MIMO) scheme, the method comprising:
if a codeword to be transmitted in a first time interval is input, generating a unitary space-time matrix to correspond to the codeword;
multiplying the unitary space-time matrix by a first final transmission matrix denoting signals transmitted in a second time interval before the first time interval, thereby generating a second final transmission matrix denoting signals to be transmitted in the second time interval; and
transmitting signals corresponding to the second final transmission matrix through a plurality of transmit antennas in the second time interval.

2. The method as claimed in claim 1, wherein generating the unitary space-time matrix comprises
generating a first matrix to correspond to the codeword; and
generating the unitary space-time matrix from the first matrix by using a Gram-Schumidt scheme.

3. The method as claimed in claim 2, wherein the first matrix is expressed by
$${Z}_{v + 1} = ( \begin{matrix}{α}_{1 , 1} {z}_{v + 1 , 1 , 1} & 0 & … & 0 & 0 \\ {α}_{1 , 2} {z}_{v + 1 , 1 , 2} & {α}_{2 , 1} {z}_{v + 1 , 2 , 1} & … & 0 & 0 \\ 0 & {α}_{2 , 2} {z}_{v + 1 , 2 , 2} & … & 0 & 0 \\ 0 & 0 & … & 0 & 0 \\ ⋮ & ⋮ & ⋰ & ⋮ & ⋮ \\ 0 & 0 & … & {α}_{L - 1 , 1} {z}_{v + 1 , L - 1 , 1} & 0 \\ 0 & 0 & … & {α}_{L - 1 , 2} {z}_{v + 1 , L - 1 , 2} & {α}_{L , 1} {z}_{v + 1 , L , 1}\end{matrix} ) ,$$
when a number of transmit antennas is two, wherein, Z₍ᵥ₊₁₎ denotes the first matrix, i denotes an index representing blocks constituting the codeword, v denotes an index representing a time interval, j denotes an index representing a transmit antenna, L denotes a number of blocks constituting the codeword, and α_{i,j} denotes a normalization weight multiplied to an i^{th} block transmitted through a j^{th} transmit antenna.

4. The method as claimed in claim 3, wherein generating the unitary space-time matrix from the first matrix by using the Gram-Schumidt scheme comprises:
setting respective nonzero column vectors of the first matrix as (v₁, v₂, v₃, . . . , v_{L}) and setting respective column vectors of the unitary space-time matrix as (u₁, u₂, u₃, . . . , u_{L}); and
generating a first column vector u₁ of the unitary space-time matrix from the first column vector v₁ of the first matrix as expressed by u₁=k₁v₁, and generating a second column vector u₂ to an L^{th} column vector u_{L} of the unitary space-time matrix from the second column vector v₂ to an L^{th} column vector v_{L} of the first matrix as expressed by an =kᵢ(vᵢ−<v₁,u₁>u₁−vᵢ,u₂>u₂− . . . −<vᵢ,uᵢ₋₁>uᵢ₋₁),
wherein k₁ exceeding zero (k₁>0) must be selected so as to satisfy (|u₁|=1).

5. The method as claimed in claim 4, wherein the first column vector u₁ of the unitary space-time matrix is expressed by
$${u}_{1} = {k}_{1} ( \begin{matrix}{α}_{11} {z}_{v + 1 , 1 , 1} \\ {α}_{12} {z}_{v + 1 , 1 , 2} \\ 0 \\ ⋮ \\ 0\end{matrix} ) .$$

6. The method as claimed in claim 4, wherein an i^{th} column vector uᵢ of the unitary space-time matrix is expressed by an
$${u}_{i} = {k}_{i} ( \begin{matrix}{α}_{i 1} {z}_{v + 1 , i , 1} {u}_{( i - 1 ) i}^{*} {u}_{( i - 1 ) 1} \\ {α}_{i 1} {z}_{v + 1 , i , 1} {u}_{( i - 1 ) i}^{*} {u}_{( i - 1 ) 2} \\ ⋮ \\ {α}_{i 1} {z}_{v + 1 , i , 1} ( 1 - {E}_{{u}_{( i - 1 ) i}} ) \\ {α}_{i 2} {z}_{v + 1 , i , 2} \\ 0 \\ ⋮ \\ 0\end{matrix} )$$

7. The method as claimed in claim 4, wherein the L^{th} column vector u_{L} of the unitary space-time matrix is expressed by an
$${u}_{L} = {k}_{L} ( \begin{matrix}{α}_{L 1} {z}_{v + 1 , L , 1} {u}_{( L - 1 ) L}^{*} {u}_{( L - 1 ) 1} \\ {α}_{L 1} {z}_{v + 1 , L , 1} {u}_{( L - 1 ) L}^{*} {u}_{( L - 1 ) 2} \\ ⋮ \\ {α}_{L 1} {z}_{v + 1 , L , 1} ( 1 - {E}_{{u}_{( L - 1 ) L}} )\end{matrix} ) .$$

8. The method as claimed in claim 4, wherein the normalization weight α_{i,j} multiplied to a first block is expressed by an

|α₁₁|²|z_{v+1,1,1}|=|α₁₂|²|z_{v+1,1,2}|=0.5.

9. The method as claimed in claim 4, wherein the normalization weight α_{i,j} multiplied to a second block to a (L−1)^{th} block is expressed by an
$${\vert {α}_{i 1} \vert}^{2} {\vert {z}_{v + 1 , i , 1} \vert}^{2} \{ {E}_{{u}_{( i - 1 ) i}} {\sum }_{j = 1}^{i - 1} {E}_{{u}_{( i - 1 ) i}} + {( 1 - {E}_{{u}_{( i - 1 ) i}} )}^{2} \} = {\vert {α}_{i 2} \vert}^{2} {\vert {z}_{v + 1 , i , 2} \vert}^{2} = 0.5 ,$$
wherein, Eᵤ_{_{(i−1)i}} denotes energy of u₍ᵢ₋₁₎ᵢ.

10. The method as claimed in claim 4, wherein the normalization weight α_{i,j} multiplied to an L^{th} block is expressed by an
$${\vert {α}_{L 1} \vert}^{2} {\vert {z}_{v + 1 , L , 1} \vert}^{2} \{ {E}_{{u}_{( L - 1 ) L}} {\sum }_{j = 1}^{L - 1} {E}_{{u}_{( L - 1 ) j}} + {( 1 - {E}_{{u}_{( L - 1 ) L}} )}^{2} \} = 1 ,$$
wherein, Eᵤ_{_{(i−1)i}} denotes energy of u₍ᵢ₋₁₎ᵢ.

11. A system for transmitting signals in a mobile communication system using a Multiple Input Multiple Output (MIMO) scheme, the system comprising:
a transmission matrix generator for, if a codeword to be transmitted in a first time-interval is input, generating a unitary space-time matrix to correspond to the codeword;
a multiplier for multiplying the unitary space-time matrix by a first final transmission matrix denoting signals transmitted in a second time interval before the first time interval, thereby generating a second final transmission matrix denoting signals to be transmitted in the second time interval; and
a Radio Frequency (RF) processor for transmitting signals corresponding to the second final transmission matrix through a plurality of transmit antennas in the second time interval.

12. The system as claimed in claim 11, wherein the transmission matrix generator generates a first matrix to correspond to the codeword, and generates the unitary space-time matrix from the first matrix by using a Gram-Schumidt scheme.

13. The system as claimed in claim 12, wherein the first matrix is expressed by
$${Z}_{v + 1} = ( \begin{matrix}{α}_{1 , 1} {z}_{v + 1 , 1 , 1} & 0 & … & 0 & 0 \\ {α}_{1 , 2} {z}_{v + 1 , 1 , 2} & {α}_{2 , 1} {z}_{v + 1 , 2 , 1} & … & 0 & 0 \\ 0 & {α}_{2 , 2} {z}_{v + 1 , 2 , 2} & … & 0 & 0 \\ 0 & 0 & … & 0 & 0 \\ ⋮ & ⋮ & ⋰ & ⋮ & ⋮ \\ 0 & 0 & … & {α}_{L - 1 , 1} {z}_{v + 1 , L - 1 , 1} & 0 \\ 0 & 0 & … & {α}_{L - 1 , 2} {z}_{v + 1 , L - 1 , 2} & {α}_{L , 1} {z}_{v + 1 , L , 1}\end{matrix} ) ,$$
when a number of transmit antennas is two, wherein, Z₍ᵥ₊₁₎ denotes the first matrix, i denotes an index representing blocks constituting the codeword, v denotes an index representing a time interval, j denotes an index representing a transmit antenna, L denotes a number of blocks constituting the codeword, and α_{i,j} denotes a normalization weight multiplied to an i^{th} block transmitted through a j^{th} transmit antenna.

14. The system as claimed in claim 13, wherein transmission matrix generator sets respective nonzero column vectors of the first matrix as (v₁, v₂, v₃, . . . , v_{L}), sets respective column vectors of the unitary space-time matrix as (u₁, u₂, u₃, . . . , u_{L}), generates a first column vector u_{L} of the unitary space-time matrix from the first column vector v₁ of the first matrix as expressed by u₁=k₁v₁, and generates a second column vector u₂ to an L^{th} column vector U_{L} of the unitary space-time matrix from the second column vector v₂ to an L^{th} column vector v_{L} of the first matrix as expressed by uᵢ=kᵢ(vᵢ−<v₁,u₁>u₁−vᵢ,u₂>u₂− . . . −<vᵢ,uᵢ₋₁>uᵢ₋₁),
wherein k₁ exceeding zero (k₁>0) must be selected so as to satisfy (|u₁|=1).

15. The system as claimed in claim 14, wherein the first column vector u₁ of the unitary space-time matrix is expressed by
$${u}_{1} = {k}_{1} ( \begin{matrix}{α}_{11} {z}_{v + 1 , 1 , 1} \\ {α}_{12} {z}_{v + 1 , 1 , 2} \\ 0 \\ ⋮ \\ 0\end{matrix} ) .$$

16. The system as claimed in claim 14, wherein an iₜₕ column vector uᵢ of the unitary space-time matrix is expressed by
$${u}_{i} = {k}_{i} ( \begin{matrix}{α}_{i 1} {z}_{v + 1 , i , 1} {u}_{( i - 1 ) i}^{*} {u}_{( i - 1 ) 1} \\ {α}_{i 1} {z}_{v + 1 , i , 1} {u}_{( i - 1 ) i}^{*} {u}_{( i - 1 ) 2} \\ ⋮ \\ {α}_{i 1} {z}_{v + 1 , i , 1} ( 1 - {E}_{{u}_{( i - 1 ) i}} ) \\ {α}_{i 2} {z}_{v + 1 , i , 2} \\ 0 \\ ⋮ \\ 0\end{matrix} ) .$$

17. The system as claimed in claim 14, wherein the L^{th} column vector u_{L} of the unitary space-time matrix is expressed by
$${u}_{L} = {k}_{L} ( \begin{matrix}{α}_{L 1} {z}_{v + 1 , L , 1} {u}_{( L - 1 ) L}^{*} {u}_{( L - 1 ) 1} \\ {α}_{L 1} {z}_{v + 1 , L , 1} {u}_{( L - 1 ) L}^{*} {u}_{( L - 1 ) 2} \\ ⋮ \\ {α}_{L 1} {z}_{v + 1 , L , 1} ( 1 - {E}_{{u}_{( L - 1 ) L}} )\end{matrix} ) .$$

18. The system as claimed in claim 14, wherein a normalization weight α_{i,j} multiplied to a first block is expressed by

|α₁₁|²|z_{v+1,1,1}|=|α₁₂|²|z_{v+1,1,2}|=0.5.

19. The system as claimed in claim 14, wherein a normalization weight α_{i,j} multiplied to a second block to a (L−1)^{th} block is expressed by
$${\vert {α}_{i 1} \vert}^{2} {\vert {z}_{v + 1 , i , 1} \vert}^{2} \{ {E}_{{u}_{( i - 1 ) i}} {\sum }_{j = 1}^{i - 1} {E}_{{u}_{( i - 1 ) i}} + {( 1 - {E}_{{u}_{( i - 1 ) i}} )}^{2} \} = {\vert {α}_{i 2} \vert}^{2} {\vert {z}_{v + 1 , i , 2} \vert}^{2} = 0.5 ,$$
wherein, Eᵤ_{_{(i−1)i}} denotes energy of u₍ᵢ₋₁₎ᵢ.

20. The system as claimed in claim 14, wherein a normalization weight α_{i,j} multiplied to an L^{th} block is expressed by
$${\vert {α}_{L 1} \vert}^{2} {\vert {z}_{v + 1 , L , 1} \vert}^{2} \{ {E}_{{u}_{( L - 1 ) L}} {\sum }_{j = 1}^{L - 1} {E}_{{u}_{( L - 1 ) j}} + {( 1 - {E}_{{u}_{( L - 1 ) L}} )}^{2} \} = 1 ,$$
wherein, Eᵤ_{_{(i−1)i}} denotes energy of u₍ᵢ₋₁₎ᵢ.

21. A method for receiving signals by a receiver in a mobile communication system using a Multiple Input Multiple Output (MIMO) scheme, the method comprising:
if signals are received in a first time interval through a plurality of receive antennas, generating an equivalent channel matrix by using signals received in a second time interval before the first time interval; and
restoring a codeword, which has been transmitted from a transmitter corresponding to the receiver, from the received signals by using the equivalent channel matrix.

22. The method as claimed in claim 21, wherein a linear signal model in a first block is expressed by
$$[ \begin{matrix}{x}_{v + 1 , 1 , 1} \\ {x}_{v + 1 , 1 , 2} \\ ⋮ \\ {x}_{v + 1 , 1 , M}\end{matrix} ] = \frac{1}{\sqrt{2}} [ \begin{matrix}{x}_{v , 1 , 1} & {x}_{v , 2 , 1} \\ {x}_{v , 1 , 2} & {x}_{v , 2 , 2} \\ ⋮ & ⋮ \\ {x}_{v , 1 , M} & {x}_{v , 2 , M}\end{matrix} ] [ \begin{matrix}{z}_{v + 1 , 1 , 1} \\ {z}_{v + 1 , 1 , 2}\end{matrix} ] + [ \begin{matrix}{n}_{v + 1 , 1 , 1} \\ {n}_{v + 1 , 1 , 2} \\ ⋮ \\ {n}_{v + 1 , 1 , M}\end{matrix} ] ≡ {H}_{v + 1 , 1} ,$$
when a number of receive antennas used in the receiver is M and a number of blocks constituting the codeword is L, wherein, v denotes an index representing a time interval, i denotes an index representing blocks constituting the codeword, j denotes an index representing a transmit antenna, p denotes an index representing a receive antenna, x_{v+1,i,p} denotes an i^{th} block received through a p^{th} receive antenna in a (v+1)^{th} time interval, n_{v+1,i,j} denotes noise in the i^{th} block received through the p^{th} receive antenna in the (v+1)^{th} time interval, z_{v+1,i,j} denotes the i^{th} block transmitted from the transmitter through a j^{th} transmit antenna in the (v+1)^{th} time interval, and H_{v+1,1} denotes an equivalent channel matrix for the modulated symbols in the first block.

23. The method as claimed in claim 21, wherein a linear signal model in a second block to a (L−1)^{th} block is expressed by
$$\begin{matrix}[ \begin{matrix}{x}_{v + 1 , i , 1} \\ {x}_{v + 1 , i , 2} \\ ⋮ \\ {x}_{v + 1 , i , M}\end{matrix} ] = [ \begin{matrix}- {\sum }_{j = 1}^{i - 1} {x}_{v , j , 1} {u}_{( i - 1 ) i}^{*} {u}_{( i - 1 ) j} + {x}_{v , i , 1} ( 1 - {E}_{{u}_{( i - 1 ) i}} ) \frac{1}{\sqrt{2}} {x}_{v , 2 , 1} \\ - {\sum }_{j = 1}^{i - 1} {x}_{v , j , 2} {u}_{( i - 1 ) i}^{*} {u}_{( i - 1 ) j} + {x}_{v , i , 2} ( 1 - {E}_{{u}_{( i - 1 ) i}} ) \frac{1}{\sqrt{2}} {x}_{v , 2 , 2} \\ ⋮ \\ - {\sum }_{j = 1}^{i - 1} {x}_{v , j , M} {u}_{( i - 1 ) i}^{*} {u}_{( i - 1 ) j} + {x}_{v , i , M} ( 1 - {E}_{{u}_{( i - 1 ) i}} ) \frac{1}{\sqrt{2}} {x}_{v , 2 , M}\end{matrix} ] \\ [ \begin{matrix}{z}_{v + 1 , i , 1} \\ {z}_{v + 1 , i , 2}\end{matrix} ] + \\ [ \begin{matrix}{n}_{v + 1 , i , 1} \\ {n}_{v + 1 , i , 2} \\ ⋮ \\ {n}_{v + 1 , i , M}\end{matrix} ] ≡ {H}_{ v + 1 , i}\end{matrix}$$
when a number of receive antennas used in the receiver is M and a number of blocks constituting the codeword is L,
wherein, v denotes an index representing a time interval, i denotes an index representing blocks constituting the codeword, j denotes an index representing a transmit antenna, p denotes an index representing a receive antenna, x_{v+1,i,p} denotes an i^{th} block received through a p^{th} receive antenna in a (v+1)^{th} time interval, n_{v+1,i,j} denotes noise in the i^{th} block received through the p^{th} receive antenna in the (v+1)^{th} time interval, z_{v+1,i,j} denotes the i^{th} block transmitted from the transmitter through a j^{th} transmit antenna in the (v+1)^{th} time interval, H_{v+1,i} denotes an equivalent channel matrix for the modulated symbols in the i-th block, and Eᵤ_{_{(i−1)i}} denotes energy of u₍ᵢ₋₁₎ᵢ.

24. The method as claimed in claim 21, wherein a linear signal model in a second block to a L^{th} block is expressed by
$$\begin{matrix}[ \begin{matrix}{x}_{v + 1 , L , 1} \\ {x}_{v + 1 , L , 2} \\ ⋮ \\ {x}_{v + 1 , L , M}\end{matrix} ] = [ \begin{matrix}- {\sum }_{j = 1}^{L - 1} {x}_{v , j , 1} {u}_{( L - 1 ) L}^{*} {u}_{( i - 1 ) j} + {x}_{v , L , 1} ( 1 - {E}_{{u}_{( L - 1 ) L}} ) \\ - {\sum }_{j = 1}^{L - 1} {x}_{v , j , 2} {u}_{( L - 1 ) L}^{*} {u}_{( L - 1 ) j} + {x}_{v , L , 2} ( 1 - {E}_{{u}_{( L - 1 ) L}} ) \\ ⋮ \\ - {\sum }_{j = 1}^{L - 1} {x}_{v , j , M} {u}_{( L - 1 ) L}^{*} {u}_{( L - 1 ) j} + {x}_{v , L , M} ( 1 - {E}_{{u}_{( L - 1 ) L}} )\end{matrix} ] {z}_{v + 1 , L , 1} + \\ [ \begin{matrix}{n}_{v + 1 , L , 1} \\ {n}_{v + 1 , L , 2} \\ ⋮ \\ {n}_{v + 1 , L , M}\end{matrix} ] ≡ {H}_{ v + 1 , L}\end{matrix}$$
when a number of receive antennas used in the receiver is M and a number of blocks constituting the codeword is L, wherein, v denotes an index representing a time interval, i denotes an index representing blocks constituting the codeword, j denotes an index representing a transmit antenna, p denotes an index representing a receive antenna, x_{v+1,i,p} denotes an i^{th} block received through a p^{th} receive antenna in a (v+1)^{th} time interval, n_{v+1,i,j} denotes noise in the i^{th} block received through the p^{th} receive antenna in the (v+1)^{th} time interval, z_{v+1,i,j} denotes the i^{th} block transmitted from the transmitter through a j^{th} transmit antenna in the (v+1)^{th} time interval, H_{v+1,L} denotes an equivalent channel matrix for the modulated symbol in the L-th block, and Eᵤ_{_{(L−1)L}} denotes energy of u_{(L-1)L}.

25. A system for receiving signals in a mobile communication system using a Multiple Input Multiple Output (MIMO) scheme, the system comprising:
an equivalent channel matrix generator for, if signals are received in a first time interval through a plurality of receive antennas, generating an equivalent channel matrix by using signals received in a second time before the first time interval; and
a MIMO detector for restoring a codeword, which has been transmitted from a transmitter corresponding to the receiver, from the received signals by using the equivalent channel matrix.

26. The system as claimed in claim 25, wherein a linear signal model in a first block is expressed by
$$[ \begin{matrix}{x}_{v + 1 , 1 , 1} \\ {x}_{v + 1 , 1 , 2} \\ ⋮ \\ {x}_{v + 1 , 1 , M}\end{matrix} ] = \frac{1}{\sqrt{2}} [ \begin{matrix}{x}_{v , 1 , 1} & {x}_{v , 2 , 1} \\ {x}_{v , 1 , 2} & {x}_{v , 2 , 2} \\ ⋮ & ⋮ \\ {x}_{v , 1 , M} & {x}_{v , 2 , M}\end{matrix} ] [ \begin{matrix}{z}_{v + 1 , 1 , 1} \\ {z}_{v + 1 , 1 , 2}\end{matrix} ] + [ \begin{matrix}{n}_{v + 1 , 1 , 1} \\ {n}_{v + 1 , 1 , 2} \\ ⋮ \\ {n}_{v + 1 , 1 , M}\end{matrix} ] ≡ {H}_{v + 1 , 1}$$
when a number of receive antennas used in the receiver is M and a number of blocks constituting the codeword is L, wherein, v denotes an index representing a time interval, i denotes an index representing blocks constituting the codeword, j denotes an index representing a transmit antenna, p denotes an index representing a receive antenna, x_{v+1,i,p} denotes an i^{th} block received through a p^{th} receive antenna in a (v+1)^{th} time interval, n_{v+1,i,j} denotes noise in the i^{th} block received through the p^{th} receive antenna in the (v+1)^{th} time interval, z_{v+1,i,j} denotes the i^{th} block transmitted from the transmitter through a j^{th} transmit antenna in the (v+1)^{th} time interval, and H_{v+1,1} denotes an equivalent channel matrix for the modulated symbols for the first block.

27. The system as claimed in claim 25, wherein a linear signal model in a second block to a (L−1)^{th} block is expressed by
$$\begin{matrix}[ \begin{matrix}{x}_{v + 1 , i , 1} \\ {x}_{v + 1 , i , 2} \\ ⋮ \\ {x}_{v + 1 , i , M}\end{matrix} ] = [ \begin{matrix}- {\sum }_{j = 1}^{i - 1} {x}_{v , j , 1} {u}_{( i - 1 ) i}^{*} {u}_{( i - 1 ) j} + {x}_{v , i , 1} ( 1 - {E}_{{u}_{( i - 1 ) i}} ) \frac{1}{\sqrt{2}} {x}_{v , 2 , 1} \\ - {\sum }_{j = 1}^{i - 1} {x}_{v , j , 2} {u}_{( i - 1 ) i}^{*} {u}_{( i - 1 ) j} + {x}_{v , i , 2} ( 1 - {E}_{{u}_{( i - 1 ) i}} ) \frac{1}{\sqrt{2}} {x}_{v , 2 , 2} \\ ⋮ \\ - {\sum }_{j = 1}^{i - 1} {x}_{v , j , M} {u}_{( i - 1 ) i}^{*} {u}_{( i - 1 ) j} + {x}_{v , i , M} ( 1 - {E}_{{u}_{( i - 1 ) i}} ) \frac{1}{\sqrt{2}} {x}_{v , 2 , M}\end{matrix} ] \\ [ \begin{matrix}{z}_{v + 1 , i , 1} \\ {z}_{v + 1 , i , 2}\end{matrix} ] + \\ [ \begin{matrix}{n}_{v + 1 , i , 1} \\ {n}_{v + 1 , i , 2} \\ ⋮ \\ {n}_{v + 1 , i , M}\end{matrix} ] ≡ {H}_{ v + 1 , i}\end{matrix}$$
when a number of receive antennas used in the receiver is M and a number of blocks constituting the codeword is L, wherein, v denotes an index representing a time interval, i denotes an index representing blocks constituting the codeword, j denotes an index representing a transmit antenna, p denotes an index representing a receive antenna, x_{v+1,i,p} denotes an i^{th} block received through a p^{th} receive antenna in a (v+1)^{th} time interval, n_{v+1,i,j} denotes noise in the i^{th} block received through the p^{th} receive antenna in the (v+1)^{th} time interval, z_{v+1,i,j} denotes the i^{th} block transmitted from the transmitter through a j^{th} transmit antenna in the (v+1)^{th} time interval, H_{v+1,i} denotes an equivalent channel matrix for the modulated symbol in the i-th block, and Eᵤ_{_{(i−1)i}} denotes energy of u₍ᵢ₋₁₎ᵢ.

28. The system as claimed in claim 25, wherein a linear signal model in a second block to a L^{th} block is expressed by
$$\begin{matrix}[ \begin{matrix}{x}_{v + 1 , L , 1} \\ {x}_{v + 1 , L , 2} \\ ⋮ \\ {x}_{v + 1 , L , M}\end{matrix} ] = [ \begin{matrix}- {\sum }_{j = 1}^{L - 1} {x}_{v , j , 1} {u}_{( L - 1 ) L}^{*} {u}_{( i - 1 ) j} + {x}_{v , L , 1} ( 1 - {E}_{{u}_{( L - 1 ) L}} ) \\ - {\sum }_{j = 1}^{L - 1} {x}_{v , j , 2} {u}_{( L - 1 ) L}^{*} {u}_{( L - 1 ) j} + {x}_{v , L , 2} ( 1 - {E}_{{u}_{( L - 1 ) L}} ) \\ ⋮ \\ - {\sum }_{j = 1}^{L - 1} {x}_{v , j , M} {u}_{( L - 1 ) L}^{*} {u}_{( L - 1 ) j} + {x}_{v , L , M} ( 1 - {E}_{{u}_{( L - 1 ) L}} )\end{matrix} ] {z}_{v + 1 , L , 1} + \\ [ \begin{matrix}{n}_{v + 1 , L , 1} \\ {n}_{v + 1 , L , 2} \\ ⋮ \\ {n}_{v + 1 , L , M}\end{matrix} ] ≡ {H}_{ v + 1 , L}\end{matrix}$$
when a number of receive antennas used in the receiver is M and a number of blocks constituting the codeword is L, wherein, v denotes an index representing a time interval, i denotes an index representing blocks constituting the codeword, j denotes an index representing a transmit antenna, p denotes an index representing a receive antenna, x_{v+1,i,p} denotes an i^{th} block received through a p^{th} receive antenna in a (v+1)^{th} time interval, n_{v+1,i,j} denotes noise in the i^{th} block received through the p^{th} receive antenna in the (v+1)^{th} time interval, zᵥ₊_{1,i,j} denotes the i^{th} block transmitted from the transmitter through a j^{th} transmit antenna in the (v+1)^{th} time interval, H_{v+1,L} denotes an equivalent channel matrix for the modulated symbol in the L-th block, and Eᵤ_{_{(L−1)L}} denotes energy of u_{(L-1)L}.
